(19) United States
(12) Patent Application Publication
(10) Pub. No.: US 2024/0394860 A1
(43) Pub. Date: Nov. 28, 2024

(54) METHOD AND ELECTRONIC DEVICE FOR PARKING LOT OPERATION BASED ON DEPTH MAP AND FOR FLOODING PREDICTION USING LEARNING MODEL

(71) Applicant: SK Planet Co., Ltd., Seongnam-si (KR)

(72) Inventor: Yeonghyeon PARK, Suwon-si (KR)

(21) Appl. No.: 18/673,313

(22) Filed: May 24, 2024

(30) Foreign Application Priority Data
May 25, 2023 (KR) 10-2023-0067681
Dec. 1, 2023 (KR) 10-2023-0171952

(51) Int. Cl. G06T 7/00; G01C 15/00; G06T 7/11; G06T 7/136; G06T 7/50; G06T 7/73; G06V 10/774; G06V 20/50; H04N 7/18

(52) U.S. Cl. CPC G06T 7/0002; G01C 15/002; G06T 7/11; G06T 7/136; G06T 7/50; G06T 7/73; G06V 10/774; G06V 20/50; H04N 7/183; G06T 2207/10016; G06T 2207/20081; G06T 2207/30242; G06V 2201/08

(57) ABSTRACT

A captured image of a target area corresponding to a parking lot is captured through a camera and generate a depth map for the captured image. Binarized data for the generated depth map is produced. The number of vehicles parked in the target area is calculated based on the binarized data, and parking situation analysis is performed according to the number of parked vehicles. Processing is performed according to a result of the parking situation analysis. Also, flooding is predicted using a learning model.

### CROSS-REFERENCE TO RELATED APPLICATIONS

The present application is based upon and claims the benefit of priority to Korean Patent Application Nos. 10-2023-0067681, filed on May 25, 2023, and 10-2023-0171952, filed on Dec. 1, 2023. The disclosures of the above-listed applications are herein incorporated by reference herein in their entirety.

### TECHNICAL FIELD

The present disclosure relates to a method and electronic device for analyzing and utilizing a parking situation based on a depth map corresponding to a parking lot image. Additionally, the present disclosure relates to a method and electronic device for predicting flooding using a learning model.

### BACKGROUND ART

If vehicles are already parked in all parking areas within the parking lot, drivers entering the parking lot will circle around the parking lot and then exit the parking lot again. If the vehicle's entry and exit directions in the parking lot are unclear, or the path for the vehicle to move is narrow due to already parked vehicles, there may be a risk of an accident occurring due to vehicles moving around the parking lot. In addition, drivers who enter the parking lot but cannot find a parking space may temporarily stop or park their vehicles anywhere, and the risk of accidents will increase with these vehicles.

To solve this problem, it is necessary to block vehicle entry when the parking lot is full. Accordingly, various methods are being used to check whether the parking lot is full. For example, there is a method of placing sensors in parking areas to check whether vehicles are parked. However, this method requires the placement of sensors in respective parking areas, the installation of wires for supplying power to the sensors and transmitting/receiving information to/from the sensors, and the management of the sensors. Therefore, this method has high system construction and management costs, so it has limitations in being applied to all parking lots.

Meanwhile, urban areas have relatively high population density and various social infrastructure, including buildings, are concentrated. Therefore, when heavy rain falls during a unit time, roads are flooded, causing traffic congestion and vehicle isolation, resulting in material and economic losses. In order to minimize material and economic losses resulting from road flooding, technology that can accurately predict road flooding is required.

### SUMMARY

Accordingly, the present disclosure is intended to provide a parking lot operation method and electronic device that can easily, quickly, and accurately process the analysis of parking lot situations.

Additionally, the present disclosure is intended to provide a flood prediction method and electronic device using a learning model.

According to an embodiment of the present disclosure, a method for a parking lot operation based on a depth map, performed by a processor, may include collecting a captured image of a target area corresponding to a parking lot through a camera; generating a depth map for the captured image; producing binarized data for the generated depth map; calculating a number of vehicles parked in the target area based on the binarized data; performing parking situation analysis according to the number of parked vehicles; and performing processing according to a result of the parking situation analysis.

In the method, producing the binarized data may include producing the binarized data through region segmentation performed by applying a threshold to the depth map.

In the method, performing the parking situation analysis may include determining a number of segmented regions corresponding to vehicle objects in the binarized data as a number of currently parked vehicles.

In the method, performing the processing may include checking whether parking is currently available, based on a value obtained by subtracting the number of currently parked vehicles from a total number of vehicles available for parking in the parking lot; when the parking is currently available, creating and delivering a parking availability message to a parking control terminal placed at an entrance of the parking lot; and when the parking is not currently available, creating and delivering a full vehicle state message to the parking control terminal placed at the entrance of the parking lot.

In the method, performing the processing may further include producing location information of a parking available zone by mapping pre-stored map information about parking zones of the parking lot and the binarized data; and transmitting the location information of the parking available zone to the parking control terminal.

The method may further include outputting at least one of an image corresponding to the parking situation analysis result or information on a number of available parking spaces on a display or to a parking control terminal placed at an entrance of the parking lot.

According to an embodiment of the present disclosure, an electronic device for a parking lot operation based on a depth map may include a communication circuit receiving a captured image of a target area corresponding to a parking lot; a memory temporarily or semi-permanently storing the received captured image; and a processor functionally connected to the communication circuit and the memory. The processor may be configured to generate a depth map for the captured image, to produce binarized data for the generated depth map, to calculate a number of vehicles parked in the target area based on the binarized data, to perform parking situation analysis according to the number of parked vehicles, and to perform processing according to a result of the parking situation analysis.

The processor may be further configured to produce the binarized data through region segmentation performed by applying a threshold to the depth map.

The processor may be further configured to determine a number of segmented regions corresponding to vehicle objects in the binarized data as a number of currently parked vehicles.

The processor may be further configured to check whether parking is currently available, based on a value obtained by subtracting the number of currently parked vehicles from a total number of vehicles available for parking in the parking lot, to, when the parking is currently available, create and deliver a parking availability message to a parking control terminal placed at an entrance of the parking lot, and to, when the parking is not currently available, create and deliver a full vehicle state message to the parking control terminal placed at the entrance of the parking lot.

The processor may be further configured to produce location information of a parking available zone by mapping pre-stored map information about parking zones of the parking lot and the binarized data, and to transmit the location information of the parking available zone to the parking control terminal.

The processor may be further configured to output at least one of an image corresponding to the parking situation analysis result or information on a number of available parking spaces on a display or to a parking control terminal placed at an entrance of the parking lot.

According to an embodiment of the present disclosure, a method for a flooding prediction, performed by a processor, may include receiving streaming images of an area including a road; detecting a road mask showing pixels representing the road from a plurality of frames arranged in time order in the streaming images through a segmentation model; measuring reflectance of an area corresponding to the road mask of the plurality of frames by controlling a reflectance measurement device; and predicting a possibility of flooding of the road by analyzing changes in reflectance corresponding to the road mask in the plurality of frames through a prediction model.

In the method, measuring the reflectance may include emitting measurement light to the area corresponding to the road mask in the plurality of frames through the reflectance measurement device and receiving reflected light corresponding to the emitted light; and measuring the reflectance through an intensity ratio of the reflected light to the measurement light.

In the method, predicting the possibility of flooding of the road may include generating a string of reflectance vectors corresponding to the road masks of the plurality of frames are arranged in time order; inputting the reflectance vector string into the prediction model; and at the prediction model, deriving a prediction vector indicating the possibility of flooding of the road by performing a plurality of operations in which learned weights are applied to the reflectance vector string.

In the method, deriving the prediction vector may include, at a plurality of calculation modules of the prediction model, calculating a plurality of state vectors through a plurality of operations in which weights are applied to the plurality of reflectance vectors arranged in time order, and calculating a plurality of output vectors by reflecting the plurality of state vectors; and at a fully connected layer of the prediction model, calculating the prediction vector by performing a plurality of operations in which weights are applied to the plurality of output vectors.

The method may further include, before receiving the streaming images, preparing learning data including a string of reflectance vectors arranged in time order and including a plurality of reflectance vectors each indicating the reflectance of the road mask area, and a label indicating the reflectance of the road mask area after a predetermined time corresponding to the reflectance vector string; inputting the reflectance vector string into a learning-uncompleted prediction model; at the prediction model, deriving a prediction vector for predicting the reflectance of the road mask area after a predetermined time by performing a plurality of operations in which learning-uncompleted weights are applied to the plurality of reflectance vectors in the reflectance vector string; calculating a loss representing a difference between the label and the prediction vector; and updating the weights of the prediction model to minimize the loss.

The method may further include, before receiving the streaming images, preparing learning data including an image of the road and a target road mask showing pixels representing the road in the image; inputting the image into a learning-uncompleted segmentation model; at the segmentation model, deriving a segmented image including a road mask from the image through a plurality of operations in which learning-uncompleted weights are applied to the image; calculating a loss representing a difference between the road mask of the segmented image and the target road mask; and performing optimization to modify the weights of the segmentation model to minimize the loss.

According to an embodiment of the present disclosure, an electronic device for a flooding prediction may include a data processor receiving streaming images of an area including a road; a road detector detecting a road mask showing pixels representing the road from a plurality of frames arranged in time order in the streaming images through a segmentation model; a reflectance measurer measuring reflectance of an area corresponding to the road mask of the plurality of frames by controlling a reflectance measurement device; and a flood predictor predicting a possibility of flooding of the road by analyzing changes in reflectance corresponding to the road mask in the plurality of frames through a prediction model.

The reflectance measurer may emit measurement light to the area corresponding to the road mask in the plurality of frames through the reflectance measurement device, receive reflected light corresponding to the emitted light, and measure the reflectance through an intensity ratio of the reflected light to the measurement light.

The flood predictor may generate a string of reflectance vectors corresponding to the road masks of the plurality of frames are arranged in time order, input the reflectance vector string into the prediction model, and enable the prediction model to derive a prediction vector indicating the possibility of flooding of the road by performing a plurality of operations in which learned weights are applied to the reflectance vector string.

The prediction model may include a plurality of calculation modules calculating a plurality of state vectors through a plurality of operations in which weights are applied to the plurality of reflectance vectors arranged in time order, and calculating a plurality of output vectors by reflecting the plurality of state vectors; and a fully connected layer calculating the prediction vector by performing a plurality of operations in which weights are applied to the plurality of output vectors.

The electronic device may further include a model creator configured to prepare learning data including a string of reflectance vectors arranged in time order and including a plurality of reflectance vectors each indicating the reflectance of the road mask area, and a label indicating the reflectance of the road mask area after a predetermined time corresponding to the reflectance vector string, to input the reflectance vector string into a learning-uncompleted prediction model, to enable the prediction model to derive a prediction vector for predicting the reflectance of the road mask area after a predetermined time by performing a plurality of operations in which learning-uncompleted weights are applied to the plurality of reflectance vectors in the reflectance vector string, to calculate a loss representing a difference between the label and the prediction vector, and to update the weights of the prediction model to minimize the loss.

The electronic device may further include a model creator configured to prepare learning data including an image of the road and a target road mask showing pixels representing the road in the image, to input the image into a learning-uncompleted segmentation model, to enable the segmentation model to derive a segmented image including a road mask from the image through a plurality of operations in which learning-uncompleted weights are applied to the image, to calculate a loss representing a difference between the road mask of the segmented image and the target road mask, and to perform optimization to modify the weights of the segmentation model to minimize the loss.

According to the present disclosure, it is possible to check whether a parking lot is full in a more economical way and also provide more accurate results by performing analysis through a depth map that has less influence on the surrounding environment.

According to the present disclosure, it is possible to predict the degree of flooding after a certain time point through a learning model. If there is a high risk of flooding, a warning can be given in advance, and thus various accidents caused by flooding can be prevented.

### BRIEF DESCRIPTION OF DRAWINGS

FIG. 1 is an exemplary diagram illustrating a depth map-based parking lot operating environment according to the first embodiment of the present disclosure.

FIG. 2 is a block diagram illustrating a camera operating device according to the first embodiment of the present disclosure.

FIG. 3 is a block diagram illustrating an electronic device according to the first embodiment of the present disclosure.

FIG. 4 is a block diagram illustrating a processor of an electronic device according to the first embodiment of the present disclosure.

FIG. 5 is an exemplary diagram illustrating an image change by processing of a captured image according to the first embodiment of the present disclosure.

FIG. 6 is a flowchart illustrating a parking lot situation analysis method in a depth map-based parking lot operation method according to the first embodiment of the present disclosure.

FIG. 7 is a flowchart illustrating a parking support method based on parking lot conditions in a depth map-based parking lot operation method according to the first embodiment of the present disclosure.

FIG. 8 is a block diagram illustrating a system for flooding prediction using a learning model according to the second embodiment of the present disclosure.

FIG. 9 is a block diagram illustrating an electronic device for flooding prediction using a learning model according to the second embodiment of the present disclosure.

FIG. 10 is a diagram illustrating a prediction model for flooding prediction according to the second embodiment of the present disclosure.

FIG. 11 is a flowchart illustrating a method for generating a segmentation model for flooding prediction according to the second embodiment of the present disclosure.

FIG. 12 is a flowchart illustrating a method for generating a prediction model for flooding prediction according to the second embodiment of the present disclosure.

FIG. 13 is a flowchart illustrating a method for flooding prediction using a learning model according to the second embodiment of the present disclosure.

FIG. 14 is an exemplary diagram illustrating a method for flooding prediction using a learning model according to the second embodiment of the present disclosure.

FIG. 15 is an exemplary diagram of a hardware system for implementing an electronic device for flooding prediction using a learning model according to the second embodiment of the present disclosure.

### DETAILED DESCRIPTION

Now, embodiments of the present disclosure will be described in detail with reference to the accompanying drawings.

However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

Additionally, the terms including expressions “first”, “second”, etc. are used for merely distinguishing one element from other elements and do not limit the corresponding elements. Also, these ordinal expressions do not intend the sequence and/or importance of the elements.

Further, when it is stated that a certain element is “coupled to” or “connected to” another element, the element may be logically or physically coupled or connected to another element. That is, the element may be directly coupled or connected to another element, or a new element may exist between both elements.

In addition, the terms used herein are only examples for describing a specific embodiment and do not limit various embodiments of the present disclosure. Also, the terms “comprise”, “include”, “have”, and derivatives thereof mean inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software.

In addition, the terms “a”, “an”, “one”, “the”, and similar terms are used herein in the context of describing the present invention (especially in the context of the following claims) may be used as both singular and plural meanings unless the context clearly indicates otherwise

Also, embodiments within the scope of the present invention include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

In the description and claims, the term “network” is defined as one or more data links that enable electronic data to be transmitted between computer systems and/or modules. When any information is transferred or provided to a computer system via a network or other (wired, wireless, or a combination thereof) communication connection, this connection can be understood as a computer-readable medium. The computer-readable instructions include, for example, instructions and data that cause a general purpose computer system or special purpose computer system to perform a particular function or group of functions. The computer-executable instructions may be binary, intermediate format instructions, such as, for example, an assembly language, or even source code.

In addition, the present invention may be implemented in network computing environments having various kinds of computer system configurations such as PCs, laptop computers, handheld devices, multiprocessor systems, microprocessor-based or programmable consumer electronics, network PCs, minicomputers, mainframe computers, mobile phones, PDAs, pagers, and the like. The present invention may also be implemented in distributed system environments where both local and remote computer systems linked by a combination of wired data links, wireless data links, or wired and wireless data links through a network perform tasks. In such distributed system environments, program modules may be located in local and remote memory storage devices.

### First Embodiment

Hereinafter, embodiments related to parking lot operation will be described with reference to the drawings.

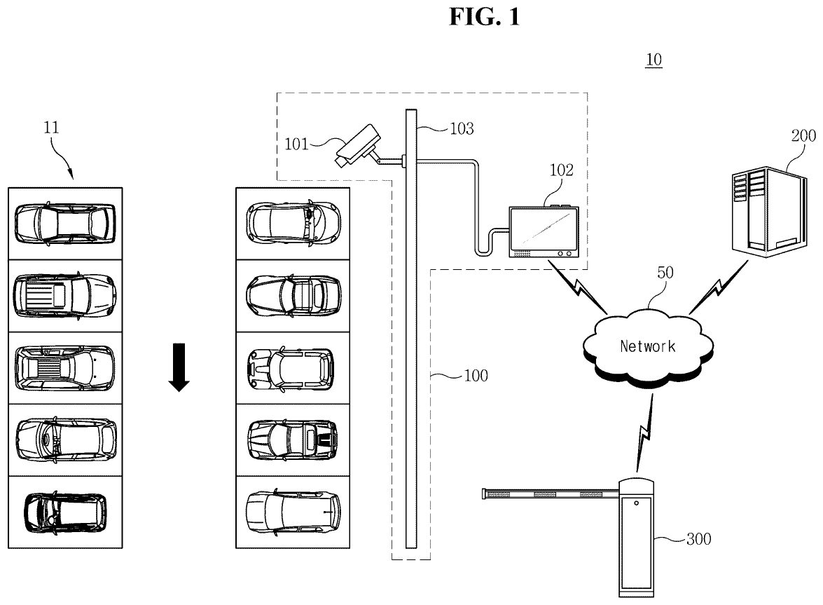

FIG. 1 is an exemplary diagram illustrating a depth map-based parking lot operating environment according to the first embodiment of the present disclosure.

Referring to FIG. 1, the parking lot operating environment 10 based on a depth map may include a camera operating device 100, a network 50, an external server device 200 (also referred to as an external electronic device or an electronic device), and a parking control terminal 300.

In the following description, regarding the parking lot operating environment 10, the camera operating device 100 collects an image (e.g., at least one of an RGB image, a thermal image, and a spectral image, hereinafter the RGB image will be mainly used as an example) and delivers the collected image to the external server device 200 via the network 50, and then the external server device 200 acquires a depth map through processing the image, performs binarization processing, and performs object detection. However, the present disclosure is not limited to this implementation. Alternatively, the camera operating device 100 and the external server device 200 may not be connected through the network 50 but may be integrated into one electronic device. That is, it may be implemented that a camera support device 102 and the external server device 200 are provided as one integrated electronic device, and a camera 101 and a movement support device 103 are connected to the integrated electronic device to photograph a target area 11. In this case, the integrated electronic device may be designed to perform the generation of a depth map for the image acquired by the camera 101, the binarization processing of the depth map, the object detection based on the binarized information, and the analysis of a parking situation according to the object detection results.

The target area 11 may include an area where the camera 101 captures an image. For example, the target area 11 may include a parking space where at least one vehicle can park, as shown. The target area 11 includes a space that can be photographed using at least one camera, and may include, for example, an outdoor parking lot. However, the present disclosure is not limited to this case, and the target area 11 may include a space such as an indoor parking lot where a plurality of vehicles can park. Additionally, the target area 11 may include a parking space consisting of not only one floor but also multiple floors. Further, in the target area 11, zone markings (e.g., parking lines) may be placed to demarcate certain parking spaces where vehicles can park.

The camera operating device 100 may photograph the target area 11 at once or multiple times, collect and store the captured image(s), and transmit the stored image(s) to the external server device 200. Here, the camera operating device 100 may transmit the captured image to the external server device 200 in real time or in response to the occurrence of a designated event, depending on the design schemes. Alternatively, based on design standards, the camera operating device 100 may transmit the captured image to the external server device 200 in real time. The camera operating device 100 may include at least one type of camera 101, the camera support device 102 that supports the operation of the camera 101, and the movement support device 103 that supports the movement of the camera 101.

The camera 101 is disposed to photograph at least a part of the target area 11, and may transmit the captured image of the target area 11 to the camera support device 102. The images that the camera 101 can acquire may include at least one of different types of images such as RGB images, thermal images, multispectral images, and hyperspectral images. In this regard, the camera 101 may include at least one of a CCTV camera, an RGB camera, a thermal imaging camera, and a spectral camera. In the following description, it is taken as an example that the camera 101 acquires an RGB image. Depending on settings or under the control of the camera support device 102, the camera 101 may be driven to acquire images of the target area 11 24 hours a day.

The camera support device 102 is connected (e.g., wiredly or wirelessly) to the camera 101, and may perform at least one of a control operation necessary for driving the camera 101, an operation of storing an image of the target area 11 acquired during the driving process of the camera 101, and an operation of transmitting the stored image of the target area 11 to the external server device 200. In addition, the camera support device 102 may generate a depth map from the acquired image of the target area 11, perform binarization on the generated depth map, and then output results in a parking situation based on the binarized data.

The camera support device 102 may generate a control signal related to the movement of the camera 101 or receive a movement-related control signal from the external server device 200, and control the movement support device 103 in response to the control signal to adjust at least one of the shooting angle and shooting time of the camera 101. In an example, if the camera 101 cannot capture the entire target area 11 at once, the camera support device 102 may divide the target area 11 into a plurality of areas and control the movement support device 103 on which the camera 101 is mounted, so that the plurality of areas can be captured separately.

In relation to receiving the control signal, transmitting the captured image to the external server device 200, or transmitting the parking situation analysis result, the camera support device 102 may include a communication module or communication circuit capable of communicating with the network 50. The camera support device 102 may access the network 50 using the communication module or communication circuit and transmit the captured image (e.g., RGB image) of the target area 11 to the external server device 200 through the network 50. Additionally, the camera support device 102 may supply power required to drive the camera 101, and for this purpose, the camera support device 102 may include a battery device or a permanent power source. Alternatively, a permanent power source may be provided to the camera 101 independently of the camera support device 102 and disposed to supply power to the camera 101 directly.

The network 50 may support establishing at least one communication channel among the camera support device 102, the external server device 200, and the parking control terminal 300. The network 50 may include, for example, a communication circuit that can be wiredly or wirelessly connected to at least one of the camera support device 102, the external server device 200, and the parking control terminal 300. In an example, the network 50 may be connected to the camera support device 102 by wire and connected to the external server device 200 and the parking control terminal 300 wirelessly. In relation to wireless connection, the network 50 may include at least one base station and base station controller. As described above, the network 50 is not limited to a specific communication type, scheme, or generation, and may include communication equipment that supports at least one of various communication schemes for signal flow among the camera support device 102, the external server device 200, and the parking control terminal 300.

The external server device 200 may be connected to the camera support device 102 through the network 50 and receive a captured image of the target area 11 from the camera support device 102. When the external server device 200 is designed to process the analysis of captured images, the external server device 200 may generate a depth map from the acquired captured images, output a parking situation analysis result based on the depth map, and perform additional operations according to the parking situation analysis result. As described above, the external server device 200 may not be connected to the camera support device 102 through the network 50, but directly connected to the camera support device 102 or integrated with the camera support device 102.

The parking control terminal 300 may access the external server device 200 or the camera support device 102 through the network 50. The parking control terminal 300 may receive a message transmitted by the external server device 200 (or the camera support device 102), and then output the received message or perform opening and closing of the entrance according to the received message. In an example, the parking control terminal 300 may receive, from the external server device 200, a parking situation analysis result generated by the external server device 200 or a guidance message according to the parking situation analysis result. Upon receiving the guidance message, the parking control terminal 300 may output a predefined alarm or vibration. Additionally, the parking control terminal 300 may access the camera support device 102 through the network 50 and, through this, may receive and output images acquired by the camera 101 in real time. In this regard, the parking control terminal 300 may include a terminal communication circuit capable of communicating with the network 50, a terminal processor capable of controlling to access the external server device 200 through the network 50 and to receive and output at least one of the parking situation analysis result and the guidance message provided by the external server device 200, and a terminal display capable of outputting at least one of the captured image of the camera 101, the parking situation analysis result, and the guidance message, and may further include a terminal memory to support storage of data related to the above-described operations. Additionally, the parking control terminal 300 may further include an open/close device capable of opening and closing the parking lot entrance and enable the open/close device to open or close the parking lot entrance in response to the received guidance message.

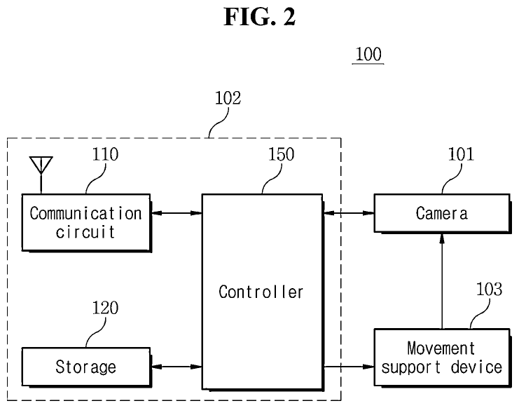

FIG. 2 is a block diagram illustrating a camera operating device according to the first embodiment of the present disclosure.

Referring to FIG. 2, the camera operating device 100 may include the camera 101, the movement support device 103, and the camera support device 102, as described above.

As previously described in FIG. 1, the camera 101 may include at least one camera module to capture at least one image of the target area 11. The at least one camera module may include at least one of, for example, an RGB camera module capable of collecting RGB images for the target area 11, a CCTV camera module capable of capturing CCTV images in the target area 11, a thermal imaging camera module capable of acquiring thermal images for the target area 11, and a spectral camera module capable of acquiring spectral images for the target area 11. The camera 101 may have a plurality of camera modules disposed at designated locations so as to cover the entire target area 11, and thus collect images of the target area 11 in real time, at regular intervals, or when a designated event occurs (e.g., the occurrence of an event due to a change in parking situation within the target area 11). The camera 101 may transmit the collected images to the camera support device 102. In the case where the camera 101 includes a plurality of camera modules arranged at different positions and certain shooting angles to capture images of the entire target area 11, the movement support device 103 may be omitted. Additionally, in the case where only one camera 101 is provided, its location may be changed by the movement support device 103.

The movement support device 103 may include a holder for holding the camera 101, a rotator capable of rotating the holder left and right or up and down by a certain angle, and a movable rail capable of moving the holder in a certain direction. The holder may have a structure that allows the camera 101 to be detachably mounted, and the shape of the holder may vary depending on the shape, case, or appearance of the camera 101. The rotator may be provided to rotate the holder in various directions by a specified angle. In an example, the rotator may include a shaft and gear capable of rotating the holder within a specified angle range in the vertical direction, a shaft and gear capable of rotating the holder within a specified angle range in the horizontal direction, a motor capable of providing a rotational force for rotation of the gears, a power source required to drive the motor, a receiving circuit capable of receiving a control signal for controlling the motor, and a board on which the receiving circuit is disposed. The movable rail may be provided at a designated location to prevent a shadow area in which the camera 101 cannot capture images of the target area 11 or to allow the camera 101 to capture the entire target area 11. For example, the movable rail may be arranged to surround the target area 11 or arranged across the target area 11 on the ceiling or upper space of the target area 11. The movable rail may include a fixing part for fixing the holder of the movement support device 103, a moving module for moving the fixing part, and a rail on which the moving module moves. The above-described movement support device 103 may receive a control signal from the movement support device 103 and, in response to the received control signal, move the camera 101 to a designated location or change the shooting angle of the camera 101. When the camera 101 includes a plurality of camera modules disposed at different positions to capture the entire target area 11, at least a part of the movement support device 103 (e.g., at least one of the movable rail and the rotator) may be omitted. In a certain example, the movement support device 103 may include a drone-type device capable of supporting aerial photography.

The camera support device 102 may include a communication circuit 110, a storage 120, and a controller 150, and may be connected to the camera 101 by wire or wirelessly.

The communication circuit 110 may include at least one communication module for establishing a communication channel of the camera support device 102. For example, the communication circuit 110 may include a first communication module (or first communication circuit) for communication connection with the camera 101, and a second communication module (or second communication circuit) for communication connection with the network 50. For example, the first communication module may include a wired communication module, and the second communication module may include a wireless communication module. The first communication module may transmit a control signal for controlling the camera 101 to the camera 101 and receive an RGB image (or thermal image, spectral image, etc.) of the target area 11 from the camera 101. The second communication module may establish a communication channel with the external server device 200, and transmit the RGB image received from the camera 101 to the external server device 200 according to predefined schedule information or in response to control of the controller 150. Additionally, the second communication module may receive a control signal related to controlling the camera 101 from the external server device 200. In the case where the camera support device 102 is designed to derive parking situation analysis results and transmit a resultant guidance message, the transmission of the RGB image to the external server device 200 may be omitted.

The storage 120 may store data or programs related to driving the camera support device 102. In an example, the storage 120 may receive an RGB image transmitted in real time by the camera 101 and store it temporarily or semi-permanently. Alternatively, in the case where the camera support device 102 is designed to derive parking situation analysis results, the storage 120 may store at least one of a depth map generation algorithm capable of generating a depth map from the acquired RGB image, a binarization program capable of binarizing the generated depth map, a parking situation analysis algorithm capable of analyzing parking situations from binarized data, and a message processing program capable of creating a designated guidance message depending on the parking situation and transmit the created message.

The controller 150 may transmit and process signals related to controlling the camera support device 102 and store or transmit processing results. In an example, the controller 150 may generate a control signal for turn-on or turn-off control of the camera 101 and transmit the generated control signal to the camera 101. The controller 150 may receive an RGB image captured and delivered by the camera 101 in real time, and temporarily or semi-permanently store the received RGB image in the storage 120. Alternatively, the controller 150 may transmit the received RGB image in real time to the external server device 200 through the network 50 in response to preset scheduling information.

In another example, when the camera support device 102 is designed to perform parking situation analysis, the controller 150 may generate a depth map from the RGB image delivered by the camera 101 and binarize the generated depth map. The controller 150 may extract a designated object from the RGB image, combine it with binarized data, and then analyze the parking situation based on the synthesized data. Alternatively, the controller 150 may count the number of regions segmented within the target area 11 based on the binarized data and return the number of vehicles per unit area photographed. In this process, the controller 150 may control the movement support device 103 such that the camera 101 scans the entire target area 11. In this process, the controller 150 may perform an identification method to prevent duplicated counting of vehicles. Alternatively, the controller 150 may recognize the boundary lines of images partially captured in the target area 11, derive the entire image based on the boundary lines, and analyze whether a vehicle exists based on the derived entire image. The controller 150 may provide the calculated total number of vehicles as a parking situation analysis result to one or more users of the parking lot entry point (or parking control terminal 300) or the control center. Depending on a scheme of managing the target area 11 (e.g., parking lot), if the total number of parking spaces in the parking lot is predefined, the controller 150 may calculate the number of available parking spaces and further provide it to the parking control terminal 300. If the parking lot is full, the controller 150 may create a prohibition guidance message prohibiting entry of additional vehicles and transmit it to the external server device 200 or the parking control terminal 300.

As described above, even if various noises depending on the environment or parked vehicles are added to the captured image of the target area 11, the camera support device 102 can clearly identify the presence or absence of a vehicle through the depth map generation and the binarization processing, and analyze the parking situation more accurately depending on the presence or absence of a vehicle. Through this, the camera support device 102 can prevent vehicles from unnecessarily entering the target area 11 for parking, thereby reducing the risk of vehicle accidents occurring within the target area 11 and accidents occurring to moving personnel. In addition, unlike the existing information provision systems based on the occupancy status of parking spaces, the camera support device 102 can provide the total number of vehicles in the parking lot, thereby avoiding a situation where vehicles enter the parking lot one after another with no remaining parking space, and reducing vehicle congestion per area in the parking lot.

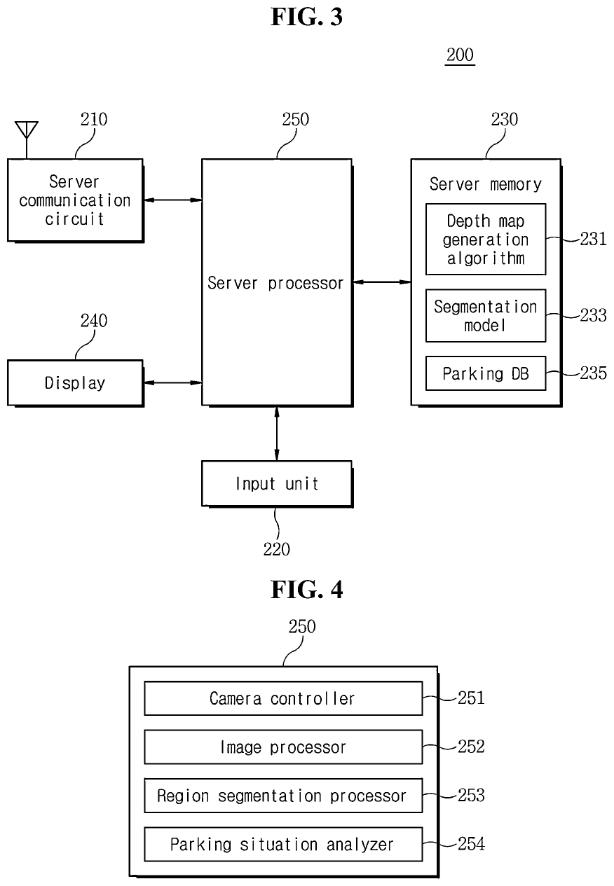

FIG. 3 is a block diagram illustrating an electronic device according to the first embodiment of the present disclosure.

As described above, although FIGS. 1 to 3 illustrate that the external server device 200 is configured separately from the camera operating device 100, the present disclosure is not limited thereto. For example, the external server device 200 may be integrated with the camera operation device 100 (or the camera support device 102). In this case, the external server device 200 is omitted, and the camera support device 102 can perform the role of the external server device 200. Hereinafter, in the description of the external server device 200 with reference to FIG. 3, a situation in which the camera support device 102 transmits the RGB image acquired by the camera 101 to the external server device 200 through the network 50 is exemplified.

Referring to FIG. 3, the external server device 200 (or electronic device) may include a server communication circuit 210 (or communication circuit), an input unit 220, a server memory 230 (or memory), a display 240, and a server processor 250 (or processor).

The server communication circuit 210 may support the establishment of a communication channel for the external server device 200. In an example, the server communication circuit 210 may include a first communication circuit capable of establishing a communication channel with the camera support device 102 through the network 50, and a second communication circuit capable of establishing a communication channel with the parking control terminal 300 through the network 50. In the case where the server communication circuit 210 forms a communication channel through the same communication scheme as the camera support device 102 and the parking control terminal 300, the server communication circuit 210 may be configured with one communication circuit. In an example, the server communication circuit 210 may receive RGB images from the camera support device 102 in real time. If the camera support device 102 is designed to have a function for generating a depth map, the server communication circuit 210 may simultaneously receive the RGB image and the depth map from the camera support device 102. The server communication circuit 210 may transmit at least one of a parking situation analysis result and a guidance message, generated by the external server device 200, to the parking control terminal 300 in response to the control of the server processor 250.

The input unit 220 may include a component that supports an administrator's input related to the operation of the external server device 200. For example, the input unit 220 may include at least one of various devices such as a keyboard, a keypad, a mouse, a touch screen, a touch pad, a touch key, a voice input device, a gesture input device, a joystick, and a wheel device. The input unit 220 may generate, in response to an administrator input, an input signal requesting a communication connection with the camera support device 102, an input signal requesting the transmission of an RGB image (or additionally a depth map) from the camera support device 102, an input signal requesting the generation of a depth map from the received RGB image, an input signal instructing binarization processing of a depth map, an input signal instructing to perform parking situation analysis based on binarized data, and an input signal controlling the transmission of a parking situation analysis result and corresponding guidance message, and then transmit the generated input signal to the server processor 250. On the other hand, when an RGB image is received, the depth map generation, binarization processing, parking situation analysis, and transmission of a guidance message may be performed under the control of the server processor 250 according to a predefined routine or schedule information even if no administrator input occurs separately.

The server memory 230 may store at least one of data and programs related to the operation of the external server device 200. For example, the external server device 200 may include a depth map generation algorithm 231, a segmentation model 233, and a parking database (DB) 235. The depth map generation algorithm 231 may generate a depth map corresponding to an RGB image delivered by the camera support device 102 based on a pre-stored depth estimation model. The depth estimation model is based on a pre-trained learning model based on deep learning, but the present disclosure is not limited to this.

The segmentation model 233 basically uses a depth map and may segment the depth map based on a threshold set by an administrator. However, the present disclosure is not limited to this scheme, and any other scheme may be applied. For example, the segmentation model 233 may include individually or in combination at least one of a region segmented by applying a threshold to a depth map at the request of an administrator, a region segmented as a vehicle region in an original image (e.g., the RGB image delivered by the camera 101) by using a pre-trained segmentation model, or a segmented region to return a bounding box of the vehicle region using an object detection model. The parking DB 235 may store, in real time or at a designated cycle, at least one of an RGB image received from the camera support device 102, a depth map generated based on the RGB image, binarized data obtained by binarizing the depth map, a parking situation analysis result obtained from the binarized data, and a guidance message created according to the parking situation analysis result. Considering the limited capacity of the server memory 230, a storage period for the RGB image and depth map may be preset, and if the storage period exceeds, previously stored data may be deleted or moved to another storage device.

The display 240 may output at least one screen related to the operation of the external server device 200. For example, the display 240 may display at least one of a screen showing the connection status with the camera support device 102, a screen showing an RGB image received in real time from the camera support device 102, a screen showing a depth map generated from the RGB image, a screen showing data obtained by binarizing the depth map, a screen detecting a vehicle object on an image segmented into regions based on the binarized data, a screen showing a parking situation analysis result according to vehicle object detection, a screen outputting a guidance message according to the parking situation analysis result, a parking lot entrance screen, and a parking lot exit screen.

The server processor 250 may perform at least one of receiving, delivering and processing signals related to the operation of the external server device 200 and storing or delivering processing results. For example, the server processor 250 may receive an RGB image from the camera support device 102 according to preset scheduling information or administrator input, generate a depth map from the received RGB image, output binarized data from the depth map, analyze a parking situation based on the binarized data, and output a guidance message according to the result of the parking situation analysis. In this regard, the server processor 250 may include a configuration as shown in FIG. 4.

FIG. 4 is a block diagram illustrating a processor of an electronic device according to the first embodiment of the present disclosure.

Referring to FIG. 4, the server processor 250 may include a camera controller 251, an image processor 252, a region segmentation processor 253, and a parking situation analyzer 254.

The camera controller 251 may generate a control signal related to the control of the camera 101 and transmit the generated control signal to the camera support device 102 through the network 50. In an example, in response to preset scheduling information or an administrator input signal, the camera controller 251 may generate a control signal related to turn-on or turn-off control of the camera 101 and a control signal for adjusting the shooting direction and shooting position of the camera 101. The camera controller 251 may establish a communication channel with the parking control terminal 300 and receive information on a situation where a vehicle enters through the parking lot entrance from the parking control terminal 300. When a vehicle enters, the camera controller 251 may control the camera 101 to request a captured image of the target area 11. In addition, the camera controller 251 may request a captured image of the target area 11 at regular intervals, and may request a captured image of the target area 11 when the parked vehicle moves. In this process, the camera controller 251 may transmit the captured image received from the camera 101 (or the camera support device 102) to the image processor 252. The camera controller 251 may control the display 240 to output an interface related to the control of the camera 101.

In another example, the camera controller 251 may request at least some of images acquired by the camera 101 at a certain period or in real time, receive the requested images, and temporarily or semi-permanently store the received images in the server memory 230. Additionally or alternatively, the camera controller 251 may provide the image acquired by the camera 101 to the parking control terminal 300 in real time or output it to the display 240 of the external server device 200. A user holding the parking control terminal 300 can check the captured image (or RGB image) provided by the external server device 200 in real time.

The image processor 252 may perform image processing on the RGB image received from the camera 101 or the camera support device 102 and stored in the server memory 230 under the control of the camera controller 251. In this regard, the image processor 252 may generate a depth map for the RGB image, using the depth map generation algorithm 231 stored in the server memory 230. The image processor 252 may perform binarization processing (or quantization processing) on the generated depth map to generate binarized data for the depth map. The image processor 252 may transmit the generated depth map and the binarized data to the region segmentation processor 253.

The region segmentation processor 253 may perform region segmentation using the depth map and binarized data received from the image processor 252. The depth map has the characteristic of providing a basis for object recognition that is relatively less affected by the color or pattern of an object. Accordingly, in the case of using the depth map, it is possible to overcome situations where it is difficult to recognize vehicles of different colors as the same type of object in the RGB image. The region segmentation processor 253 may process region segmentation using the segmentation model 233. The division model 233 may basically include a model that segments the depth map based on a threshold set by the administrator. In addition, the region segmentation processor 253 may perform of a vehicle region segmentation using at least one of a method of performing the region segmentation by applying a threshold to the depth map according to administrator's settings, a method of performing the vehicle region segmentation in an original image (e.g., a captured image) using a pre-trained segmentation model, or a method of returning a bounding box of the vehicle region using an object detection model.

The parking situation analyzer 254 may receive, from the region segmentation processor 253, information on object detection that deviates from the reference conditions. The parking situation analyzer 254 may calculate the number of vehicles by calculating the number of a plurality of segmented regions. Alternatively, the parking situation analyzer 254 may count the number of segmented regions received from the region segmentation processor 253 and return the number of vehicles per unit area photographed to the administrator. In this process, the parking situation analyzer 254 may perform an identification method to prevent duplicated counting of vehicles. For example, if there are multiple cameras observing the parking lot corresponding to the target area 11, the parking situation analyzer 254 may perform duplicate prevention processing due to a difference in the viewing angle. In addition, when the camera 101 is installed in movable equipment and scans the entire parking area corresponding to the target area 11, the parking situation analyzer 254 may perform duplicate prevention processing due to duplicate shooting. For example, the parking situation analyzer 254 may compare specific portions of edges in a plurality of images captured in the target area 11, process images containing edges similar to a predefined reference value or more as adjacent images, synthesize the adjacent images, and thereby obtain one entire image for the target area 11. The parking situation analyzer 254 may calculate the number of vehicles using the number of segmented regions (e.g., regions segmented based on the presence of vehicles) for the entire image, and provide the calculated number of vehicles to the parking control terminal 300 disposed at one or more of the parking lot entry and exit points and the control center. If the total number of parking areas in the parking lot is pre-entered, the parking situation analyzer 254 may calculate the number of available parking areas and provide it to the parking control terminal 300. Additionally, the parking situation analyzer 254 may provide the total number of vehicles parked in the parking lot to the parking control terminal 300.

As discussed hereinbefore, the external server device 200 can support avoiding a situation where vehicles enter the parking lot when there is no remaining parking space, support reducing vehicle congestion per area in the parking lot, and support reducing collisions in the parking lot.

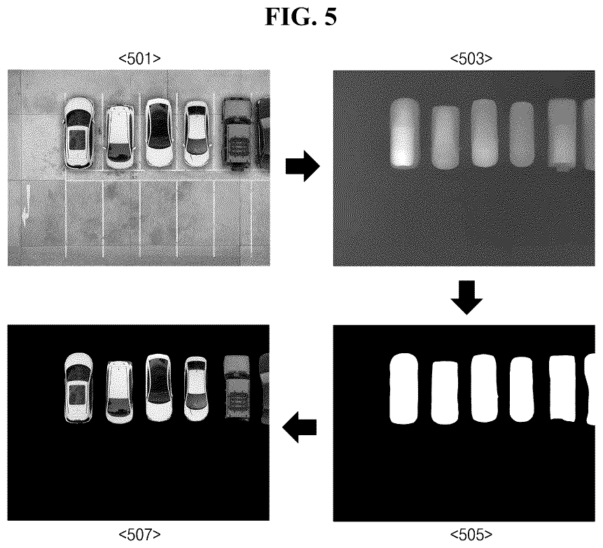

FIG. 5 is an exemplary diagram illustrating an image change by processing of a captured image according to the first embodiment of the present disclosure.

Referring to FIG. 5, various screens related to parking situation analysis for the target area 11 may be provided to an administrator of the external server device 200 or an administrator managing the parking control terminal 300. In an example, the camera 101 may capture a parking lot image corresponding to the target area 11 and sends the captured image (e.g., RGB image) such as a screen 501 to the external server device 200 or the parking control terminal 300. The administrator of the external server device 200 and the administrator of the parking control terminal 300 can visually check the current parking situation in the target area 11 through the screen 501. Meanwhile, although the screen 501 shows a captured image in the form of an aerial view, the present disclosure is not limited to this implementation.

Meanwhile, at least one of the camera support device 102 and the external server device 200 may generate a depth map as shown in a screen 503 from the RGB image transmitted by the camera 101. For the depth map generation, at least one of the camera support device 102 and the external server device 200 may use a pre-trained monocular depth estimation model. The depth map contains data that can distinguish only distance relationships, so it is possible to accurately determine whether the vehicle is parked regardless of changes in the surrounding environment of the parking lot corresponding to the target area 11 or the specificity of the vehicle (e.g., different colors of vehicles, different degrees of light reflectivity of vehicles, etc.).

At least one of the camera support device 102 and the external server device 200 may perform binarization or quantization on the generated depth map to produce binarization data as shown in a screen 505. For example, at least one of the camera support device 102 and the external server device 200 may apply a predefined threshold to the depth map and thereby distinguish regions where vehicles exist and regions where vehicles do not exist into 0 and 1 (or black and white). In another example, at least one of the camera support device 102 and the external server device 200 may detect regions where vehicles are parked by applying a pre-trained segmentation learning model to the depth map. Alternatively, at least one of the camera support device 102 and the external server device 200 may detect a vehicle object in the RGB image or depth map by applying a learning model for the vehicle objects, and distinguish vehicle parked regions based on the outline of the vehicle object.

At least one of the camera support device 102 and the external server device 200 may extract only vehicle objects by applying binarized data to the RGB image, and produce a synthesized image as shown in a screen 507 by applying the extracted vehicle objects to the binarized data.

The external server device 200 may output at least one of the screens 501 to 507 on the display 240 or provide it to the parking control terminal 300. In addition, at least one of the camera support device 102 and the external server device 200 may calculate the number of parked vehicles using at least one of the screens 505 and 507, and output the calculated number of parked vehicles on the display 240 of the external server device 200 or provide it to the parking control terminal 300.

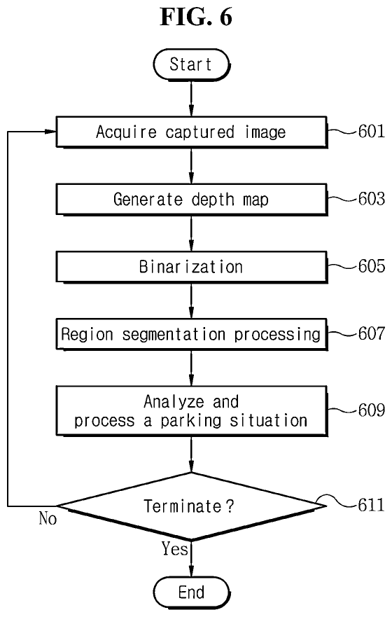

FIG. 6 is a flowchart illustrating a parking lot situation analysis method in a depth map-based parking lot operation method according to the first embodiment of the present disclosure. Hereinafter, the description will be made assuming that the external server device 200 performs parking lot situation analysis, but this operation may also be performed by the camera support device 102.

Referring to FIG. 6, in relation to the parking lot situation analysis method in the parking lot operation method based on the depth map, the server processor 250 of the external server device 200 (or the processor of the electronic device) may acquire in step 601 an image (e.g., RGB image) for the target area 11. In this regard, the server processor 250 may establish a communication channel with the camera 101 or with the camera support device 102 that stores and manages images captured by the camera 101. For example, when receiving a vehicle entry signal from the parking control terminal 300, the server processor 250 may acquire a captured image. Alternatively or additionally, the server processor 250 may acquire a captured image of the target area 11 at a predefined regular cycle and/or in real time when a change occurs in the target area 11.

In step 603, the server processor 250 may generate a depth map from the acquired image. In relation to depth map generation, the server processor 250 may use a pre-trained monocular depth estimation model. When the depth map is generated, the server processor 250 may temporarily or semi-permanently store the generated depth map in the server memory 230.

In step 605, the server processor 250 may perform binarization processing on the depth map. In relation to this, the server processor 250 may read the depth map stored in the server memory 230 and perform binarization processing on the read depth map. In relation to performing binarization processing, the server processor 250 may use at least one of a method of performing the region segmentation by applying a threshold to the depth map, a method of performing the vehicle region segmentation in an original image (e.g., a captured image) using a pre-trained segmentation model, or a method of returning a bounding box of the vehicle region using an object detection model. The external server device 200 may pre-store and manage each algorithm or learning model to support the above-described binarization processing method.

In step 607, the server processor 250 may perform region segmentation processing using the binarized data. For example, the server processor 250 may detect an area corresponding to a vehicle object as a segmented region in the binarized data and calculate the number of detected regions corresponding to the vehicle object.

In step 609, the server processor 250 may analyze and process a parking situation based on the region segmentation processing result. For example, the server processor 250 may calculate the number of parked vehicles in the target area 11 based on the number of regions corresponding to vehicle objects. In this operation, the server processor 250 may determine whether parking is available in the target area 11 by subtracting the number of currently parked vehicles from the maximum number of vehicles that can be parked in the target area 11, stored in the server memory 230. The server processor 250 may transmit the number of currently parked vehicles, whether parking is available, and/or the number of parking available vehicles to the parking control terminal 300.

In step 611, the server processor 250 may check whether an event for terminating the parking situation analysis and processing occurs. If the termination event does not occur, the server processor 250 may return to the step 601 and re-perform the subsequent operations. When the termination event occurs, the server processor 250 may terminate the parking situation analysis and processing and provide a corresponding notification message to the parking control terminal 300. The termination event may include, for example, an administrator's input requesting the termination of the parking situation analysis function, and an arrival of pre-designated parking lot operation end time. Alternatively, the server processor 250 may refrain from performing the parking situation analysis and processing when there is no movement of parked vehicles after the target area 11 is full.

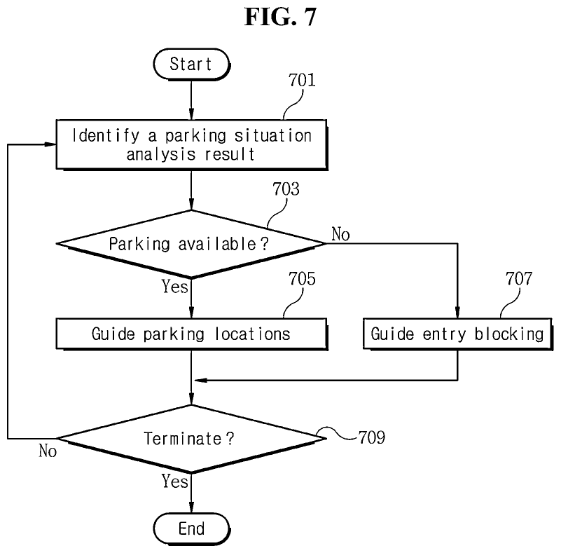

FIG. 7 is a flowchart illustrating a parking support method based on parking lot conditions in a depth map-based parking lot operation method according to the first embodiment of the present disclosure. The parking support method described below may also be performed by the camera support device 102.

Referring to FIG. 7, in relation to the parking support method based on parking lot conditions in the parking lot operation method based on the depth map, the server processor 250 of the external server device 200 (or the processor of the electronic device) may identify a parking situation analysis result in step 701. In this regard, the server processor 250 may temporarily or semi-permanently store the result of the parking situation analysis performed in FIG. 6 in the server memory 230. Thus, in order to identify the parking situation analysis result, the server processor 250 may check a designated storage region of the server memory 230.

In step 703, the server processor 250 may determine whether the parking situation analysis result indicates that parking is available. In this regard, the server processor 250 may calculate the number of segmented regions corresponding to the vehicle objects from the binarized data and map the calculated number to the number of currently parked vehicles. The server processor 250 may subtract the number of currently parked vehicles from the total number of parked vehicles pre-stored in the server memory 230 and check whether the subtraction value is greater than zero. If the subtraction result is greater than zero, the server processor 250 may determine that parking is possible, and guide parking locations in step 705. In relation to guiding available parking locations, the server processor 250 may obtain information on available parking zones by comparing information on available vehicle parking areas pre-stored in the server memory 230 with the binarized data. The server processor 250 may match location information on the available parking zones and the entire map information for the target area 11 and provide a matching result to the parking control terminal 300 (or vehicle). When a vehicle is waiting at the vehicle entrance, the parking control terminal 300 may allow the vehicle to enter. Additionally, the parking control terminal 300 may output the location information on the available parking zones through an electronic signboard and/or a speaker. Alternatively or additionally, the parking control terminal 300 may transmit the location information on the available parking zones through a wireless communication channel or in a broadcasting manner so that vehicles can receive it.

If the subtraction result is zero, the server processor 250 may determine that parking is impossible, and process guidance for blocking vehicle entry in step 707. For example, the server processor 250 may create a message for blocking vehicle entry and provide it to the parking control terminal 300. The parking control terminal 300 may output the vehicle entry block message through an electronic signboard and/or a speaker. Alternatively or additionally, the parking control terminal 300 may transmit a message indicating that the parking lot in the target area 11 is full or a reason for blocking vehicle entry to vehicles in a broadcasting manner.

In step 709, the server processor 250 may check whether a termination-related event occurs. If no termination-related event occurs, the server processor 250 may return to the step 701 and re-perform the subsequent operations. When the termination-related event (e.g., an event where the expiration time for parking lot use arrives, an event related to parking lot use closure, or an input event from an administrator related to termination) occurs, the server processor 250 may terminate the parking situation analysis and related guidance service.

Meanwhile, even if the number of detected segment regions corresponding to vehicle objects is less than the total number of vehicles that can be parked in the target area 11, the server processor 250 may determine as a full vehicle state according to the arrangement of vehicle objects. For example, the server processor 250 may compare the sizes of available parking areas and vehicle objects to detect a case where a certain vehicle object is arranged across a plurality of parking areas. Also, when a vehicle object parked at the pre-stored border of parking available areas is detected, the server processor 250 may determine as a full vehicle state even if the number of detected vehicle objects is less than the number of parking available vehicles, and perform related processing (e.g., guidance according to the full vehicle state).

By performing the depth map-based region segmentation described above, vehicle recognition that is robust to external factors is possible. In addition, it can provide parking space occupancy information by zone or section, and it is easy to improve performance because it is a software operation method that utilizes the depth map and binarized data. In addition, since a pre-trained monocular depth estimation model is used, the system can be built using only a mono-camera (i.e., single camera), the total cost can be reduced, and the precision of depth estimation can be improved by updating the depth estimation model.

### Second Embodiment

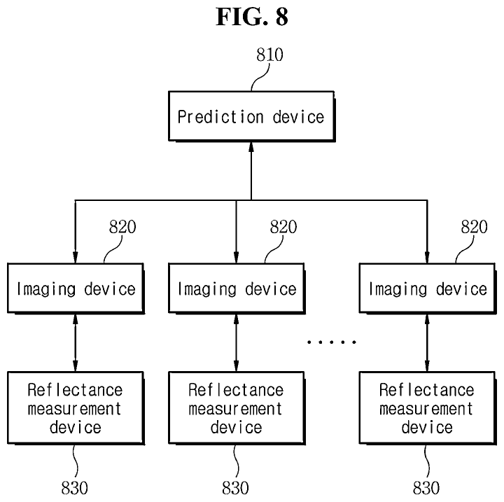

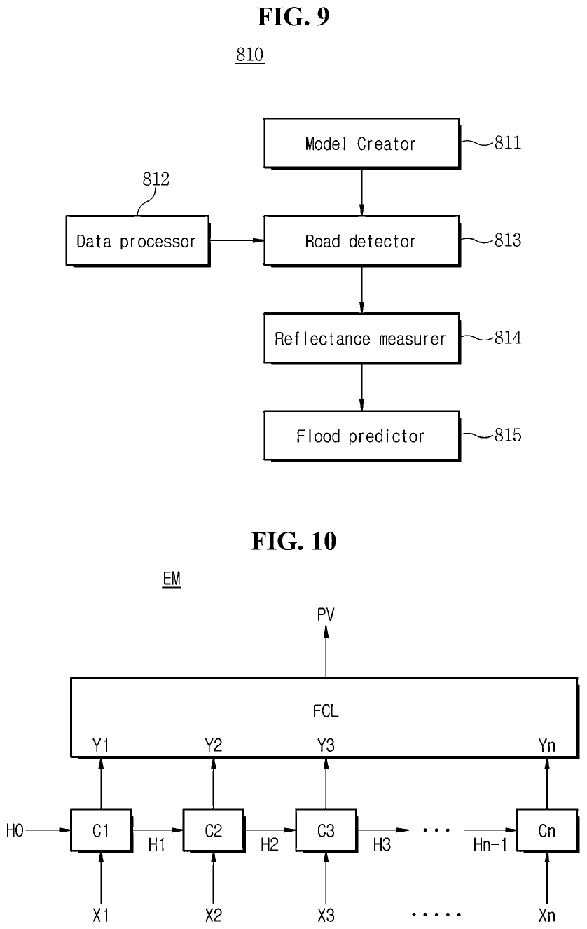

Hereinafter, a system for flooding prediction using a learning model according to the second embodiment of the present disclosure will be described. FIG. 8 is a block diagram illustrating a system for flooding prediction using a learning model according to the second embodiment of the present disclosure. FIG. 9 is a block diagram illustrating an electronic device for flooding prediction using a learning model according to the second embodiment of the present disclosure. FIG. 10 is a diagram illustrating a prediction model for flooding prediction according to the second embodiment of the present disclosure.

Referring to FIG. 8, the system according to the second embodiment of the present disclosure includes a prediction device 810, an imaging device 820, and a reflectance measurement device 830.

The imaging device 820 is configured to generate streaming images by continuously capturing an area containing a road and provide the generated streaming images to the prediction device 810. The imaging device 820 may be a closed-circuit television (CCTV). The imaging device 820 includes a camera that captures an area containing a road and generates streaming images, and a transceiver that transmits the streaming images to the prediction device 810.

The reflectance measurement device 830 is configured to measure reflectance. The reflectance measurement device 830 may emit measurement light under the control of the prediction device 810, collect reflected light corresponding to the emitted light, and derive the reflectance through the intensity ratio of the reflected light to the measurement light.

The prediction device 810 is configured to predict flooding by controlling the imaging device 820 and the reflectance measurement device 830. Referring to FIG. 9, the prediction device 810 includes a model creator 811, a data processor 812, a road detector 813, a reflectance measurer 814, and a flood predictor 815.

The model creator 811 can create a learning model including a segmentation model (SM) and a prediction model (PM) through deep learning.

The segmentation model (SM) is trained to detect a mask representing the pixels occupied by an object. In particular, the segmentation model (SM) is trained to detect a road mask which shows the pixels of a portion representing a road in an image. Examples of the segmentation model (SM) may include FCN, DeepLab, U-Net, and ReSeg.

The prediction model (PM) is trained to calculate a prediction vector representing the reflectance of the road mask after a predetermined time from a reference time point. The reflectance of the road mask after the predetermined time from the reference time point is used as an indicator of the possibility of flooding. Examples of the prediction model (PM) may include RNN (Recurrent Neural Network), LSTM (Long Short-Term Memory), etc.

The learning model including the segmentation model (SM) and the prediction model (PM) includes a plurality of layers, and each of the plurality of layers performs a plurality of operations. The operation results of a plurality of calculation modules in one layer are weighted and transmitted to the next layer. This means that weights are applied to the operation results of the current layer and inputted into the operations of the next layer. In other words, the learning model performs multiple operations to which weights of multiple layers are applied. The plurality of layers of the segmentation model (SM) may include at least one of a fully-connected layer, a convolutional layer, a recurrent layer, a graph layer, and a pooling layer. The plurality of operations may include a convolution operation, a down sampling operation, an up sampling operation, a pooling operation, and an operation using an activation function. The activation function may include sigmoid, hyperbolic tangent (tanh), Exponential Linear Unit (ELU), Rectified Linear Unit (ReLU), Leakly ReLU, Maxout, Minout, Softmax, etc.

Referring to FIG. 10, the prediction model (PM) is configured to predict the reflectance of the road mask after a predetermined time from the reference time point. The prediction model (PM) may receive a string of reflectance vectors as input. The reflectance vector string includes a plurality of reflectance vectors X1 to Xn, which are arranged in time order. The reflectance vector indicates the reflectance measured corresponding to the area of the road mask detected in a frame. That is, the plurality of reflectance vectors X1 to Xn are arranged in the order of the frames from which the road mask is detected. When the string of the reflectance vectors is inputted, the prediction model (PM) performs a plurality of operations in which weights are applied to the reflectance vector string to calculate the prediction vector (PV) indicating the reflectance of the road mask after a predetermined time.

Specifically, the prediction model (PM) includes a plurality of calculation modules Ct (C1 to Cn) corresponding to the plurality of reflectance vectors X1 to Xn arranged in time order, and a fully connected layer (FCL). The plurality of calculation modules Ct (C1 to Cn) perform a plurality of operations in which weights are applied to the reflectance vector string Xt (X1 to Xn) composed of the plurality of reflectance vectors X1 to Xn arranged in time order, and thereby calculate a plurality of state vectors Ht (H1 to Hn) and a plurality of output vectors Yt (Y1 to Yn). The state vector Ht of the current order indicates a value that reflects the reflectance vector of the current order and the state vector Ht−1 of the previous order. The output vector Yt indicates a value that reflects the state vector Ht.

The fully connected layer (FCL) performs a plurality of operations in which weights are applied to the plurality of output vectors Yt (Y1 to Yn) to calculate a prediction vector indicating the reflectance of the road mask area after a certain time from the reference time point. That is, the fully connected layer (FCL) calculates a prediction vector indicating the reflectance of the road mask area after a certain time from the capture time of the frame that is the basis of the last reflectance vector Xn among the plurality of reflectance vectors X1 to Xn arranged in time order.

The calculation module Ct consists of one or more operations to which weights are applied. Here, the operation refers to an operation applying an activation function. The activation function may include sigmoid, hyperbolic tangent (tanh), Exponential Linear Unit (ELU), Rectified Linear Unit (ReLU), Leakly ReLU, Maxout, Minout, Softmax, etc.

The calculation module Ct performs a weighted operation on the state vector Ht−1 calculated by the calculation module Ct−1 in the previous time order and the reflectivity vector Xt in the current time order, and thereby calculate the state vector Ht and the output vector Yt in the current time order.

That is, the plurality of reflectance vectors X1 to Xn arranged in time order are inputted to the first to nth calculation modules C1 to Cn, respectively. Then, each of the first to nth calculation modules C1 to Cn performs a weighted operation on the state vector Ht−1 of the previous order calculated by the calculation module Ct−1 of the previous order and the reflectance vector Xt of the current order to calculate the state vector Ht of the current order, and delivers the calculated state vector Ht to the calculation module Ct+1 of the next order. In addition, each of the first to nth calculation modules C1 to Cn performs an operation in which a weight is applied to the state vector Ht of the current order, thereby calculating and outputting the output vector Yn of the current order.

Referring again to FIG. 9, the data processor 812 receives streaming images of an area including a road from the imaging device 820.

The road detector 813 detects the road mask showing pixels representing a road in a plurality of frames, arranged in time order, of the streaming images through the segmentation model (SM).

The reflectance measurer 814 controls the reflectance measurement device 830 to measure the reflectance of an area corresponding to the road mask in the plurality of frames.

The flood predictor 815 predicts the possibility of flooding of a road by analyzing the change in reflectance corresponding to the road mask of a plurality of frames through the prediction model (PM). At this time, the flood predictor 815 may derive a prediction vector indicating the possibility of flooding through the prediction model (PM), and if the possibility of flooding is greater than a predetermined value according to the derived prediction vector (i.e., if the value of the prediction vector is greater than a predetermined value), provide a warning message indicating the possibility of flooding to relevant organizations.

The specific operations of the prediction device 810, including the model creator 811, the data processor 812, the road detector 813, the reflectance measurer 814, and the flood predictor 815, will be described in detail below.

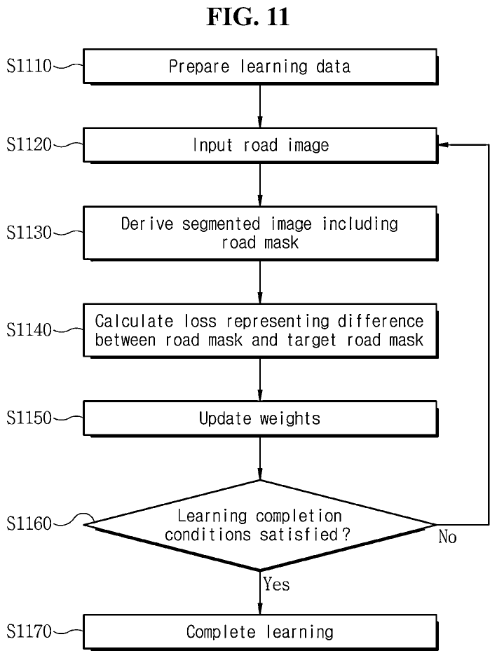

Next, a method for generating a segmentation model for flooding prediction using a learning model will be described. FIG. 11 is a flowchart illustrating a method for generating a segmentation split model for flooding prediction according to the second embodiment of the present disclosure.

Referring to FIG. 11, the model creator 811 prepares learning data in step S1110. The learning data includes an image of a road, and a target road mask showing pixels representing the road in the image. Here, the image of the road may be one frame of streaming images.

Once the learning data is prepared, the model creator 811 inputs the image of the road into the segmentation model (SM) in step S1120.

Then, in step S1130, the segmentation model (SM) performs a plurality of operations in which learning-uncompleted weights are applied, and thereby derives a segmented image including a road mask showing pixels representing the road in the image.

Then, in step S1140, the model creator 811 calculates a loss representing a difference between the road mask of the segmented image and a target road mask through a loss function.

Next, in step S1150, the model creator 811 updates the weights of the segmentation model (SM) to minimize the loss through optimization.

Next, in step S1160, the model creator 811 determines whether a predetermined learning completion condition is satisfied. This condition may include, for example, a case where the loss is less than a predetermined threshold, a case where a learning rate is greater than a predetermined value, or a case where a predetermined evaluation index is satisfied.

If the predetermined learning completion condition is not satisfied, the model creator 811 repeats the above-described steps S1120 to S1160 using a plurality of other learning data. On the other hand, if the predetermined learning completion condition is satisfied, the model creator 811 completes learning in step S1170.

As such, when the image of the road is inputted, the segmentation model (SM) is created that derives the segmented image including the road mask by performing the plurality of operations applying learned weights to the image.

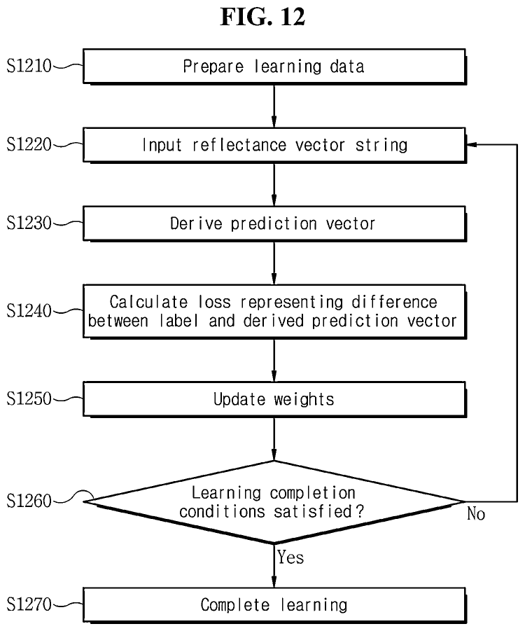

Next, a method for generating a prediction model (PM) for flooding prediction will be described. FIG. 12 is a flowchart illustrating a method for generating a prediction model for flooding prediction according to the second embodiment of the present disclosure.

Referring to FIG. 12, the model creator 811 prepares learning data in step S1210. The learning data includes a string of reflectance vectors and a label corresponding to the reflectance vector string. Here, the reflectance vector string includes a plurality of reflectance vectors arranged in time order. In particular, each of the plurality of reflectance vectors indicates the reflectance of the road mask area. The label indicates the reflectance of the road mask area after a predetermined time from the reference time point (i.e., the capture time of the frame that is the basis of the last reflectance vector Xn among the plurality of reflectance vectors X1 to Xn arranged in time order) corresponding to the reflectance vector string.

The model creator 811 inputs the reflectance vector string Xt including the plurality of reflectance vectors X1 to Xn into the prediction model (PM) in step S1220. When the reflectance vector string Xt is inputted, the segmentation model (SM) performs a plurality of operations in which learning-uncompleted weights are applied to the reflectance vector string Xt (X1 to Xn), and thereby derives in step S1230 a prediction vector (PV) that predicts the reflectance of the road mask area after the predetermined time.

Then, in step S1240, the model creator 811 calculates a loss representing a difference between the label and the derived prediction vector through a loss function. Then, in step S1250, the model creator 811 updates the weights of the prediction model (PM) to minimize the loss through optimization.

Next, in step S1260, the model creator 811 determines whether a predetermined learning completion condition is satisfied. This condition may include, for example, a case where the loss is less than a predetermined threshold, a case where a learning rate is greater than a predetermined value, or a case where a predetermined evaluation index is satisfied.

If the predetermined learning completion condition is not satisfied, the model creator 811 repeats the above-described steps S1220 to S1260 using a plurality of other learning data. On the other hand, if the predetermined learning completion condition is satisfied, the model creator 811 completes learning in step S1270.

As such, when the reflectance vector string Xt (X1 to Xn) including the plurality of reflectance vectors X1 to Xn arranged in time order is inputted, the prediction model (PM) is created that calculates the prediction vector indicating the reflectance of the road mask area after a certain time by performing the plurality of operations applying learned weights to the reflectance vector string Xt.

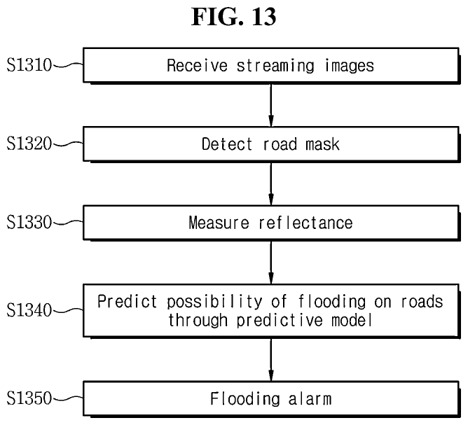

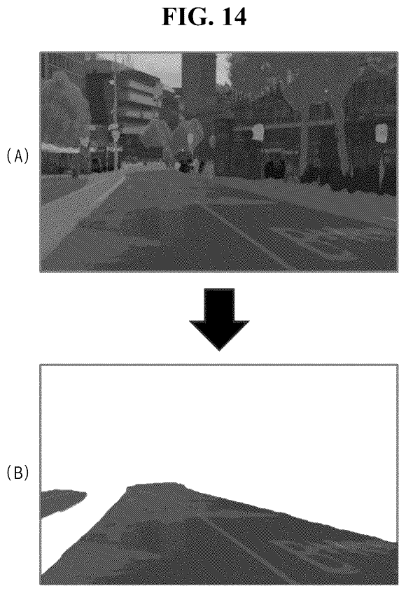

Next, a method for flooding prediction using a learning model will be described. FIG. 13 is a flowchart illustrating a method for flooding prediction using a learning model according to the second embodiment of the present disclosure. FIG. 14 is an exemplary diagram illustrating a method for flooding prediction using a learning model according to the second embodiment of the present disclosure.

Referring to FIG. 13, in step S1310, the data processor 812 receives streaming images captured of an area including a road.

Next, in step S1320, the road detector 813 detects a road mask showing pixels representing a road from a plurality of frames arranged in time order in the streaming images through the segmentation model (SM).

For example, one frame is illustrated in (A) of FIG. 14. Through the segmentation model (SM), the road detector 813 can detect the road mask showing pixels representing a road as shown in (B) of FIG. 14.

Next, in step S1330, the reflectance measurer 814 controls the reflectance measuring device 830 to measure the reflectance of the area corresponding to the road mask of the plurality of frames.

At this time, the reflectance measurer 814 may emit measurement light to an area corresponding to the road mask of the plurality of frames through the reflectance measuring device 830, collect reflected light corresponding to the emitted light, and then measure the reflectance through the intensity ratio of the reflected light to the measurement light.

Next, in step S1340, the flooding predictor 815 predicts the possibility of flooding of the road by analyzing the change in reflectance corresponding to the road mask of the plurality of frames through the prediction model (PM).

Specifically, in the step S1340, the flooding predictor 815 generates a reflectance vector string in which reflectance vectors corresponding to the road mask of the plurality of frames are arranged in time order. Then, the flooding predictor 815 inputs the reflectance vector string into the prediction model (PM). Then, the prediction model (PM) performs a plurality of operations in which learned weights are applied to the reflectance vector string, and thereby derives a prediction vector indicating the possibility of flooding of the road. The prediction vector indicates the reflectance of the road mask area after a predetermined time from the reference time point, that is, the time point when the frame that is the basis of the last reflectance vector Xn among the plurality of reflectance vectors X1 to Xn is captured. Accordingly, the reflectance of the derived prediction vector indicates the degree of flooding, and thus, the higher the value of the prediction vector, the higher the possibility of flooding.

Referring again to FIG. 10, the method by which the prediction model (PM) in step S1340 derives the prediction vector is as follows. The plurality of calculation modules Ct (C1 to Cn) of the prediction model (PM) calculate the plurality of state vectors Ht (H1 to Hn) through a plurality of operations in which weights are applied to the plurality of reflectance vectors Xt (X1 to Xn) arranged in time order, and calculate the plurality of output vectors Yt (Y1 to Yn) by reflecting the plurality of state vectors Ht (H1 to Hn). Then, the fully connected layer (FCL) of the prediction model (PM) can calculate the prediction vector by performing a plurality of operations in which weights are applied to the plurality of output vectors Yt (Y1 to Yn).

In this case, if the possibility of flooding is greater than a predetermined value according to the prediction vector derived previously (S340) (i.e., if the value of the prediction vector is greater than a predetermined value), the flooding predictor 815 may provide a warning message about the possibility of flooding to the relevant organizations in step S1350.

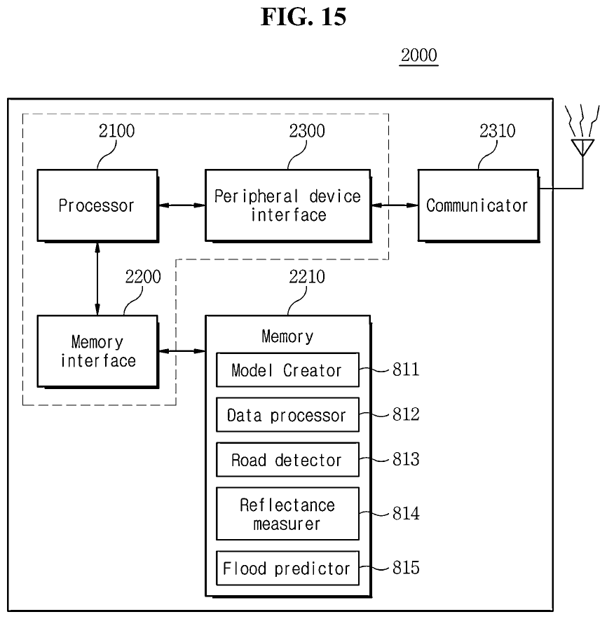

FIG. 15 is an exemplary diagram of a hardware system for implementing an electronic device for flooding prediction using a learning model according to the second embodiment of the present disclosure.

As shown in FIG. 15, the hardware system 2000 according to an embodiment of the present disclosure may include a processor 2100, a memory interface 2200, and a peripheral device interface 2300.

These respective elements in the hardware system 2000 may be individual components or be integrated into one or more integrated circuits and may be combined by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

In the memory 2210, the model creator 811, the data processor 812, the road detector 813, the reflectance measurer 814, and the flood predictor 815, previously described with reference to FIG. 9, may be stored in the form of software modules, and further an operating system (OS) may be additionally stored. The model creator 811, the data processor 812, the road detector 813, the reflectance measurer 814, and the flood predictor 815 may be loaded into the processor 2100 and executed.

Each the model creator 811, the data processor 812, the road detector 813, the reflectance measurer 814, and the flood predictor 815 may be implemented in the form of a software module or hardware module executed by a processor or as a combination of a software module and a hardware module.

As such, a software module, a hardware module, or a combination thereof, executed by a processor, may be implemented as an actual hardware system (e.g., a computer system).

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices.

The peripheral devices are to provide different functions to the hardware system 2000, and in one embodiment of the present invention, a communicator 2310 may be included, for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), 5G communication system, Wireless Mobile Broadband Service (WMBS), Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and the like. In addition, as wired communication networks, wired Local Area Network (LAN), wired Wide Area Network (WAN), Power Line Communication (PLC), USB communication, Ethernet, serial communication, optical/coaxial cables, etc. may be included. This is not a limitation, and any protocol capable of providing a communication environment with other devices may be included.

In the hardware system 2000 according to an embodiment of the present invention, each element of the interpolation device 10 stored in the memory 2210 in the form of a software module performs an interface with the communicator 2310 via the memory interface 2200 and the peripheral device interface 2300 in the form of a command executed by the processor 2100.

While the specification contains many specific implementation details, these should not be construed as limitations on the scope of the present disclosure or of what may be claimed, but rather as descriptions of features that may be specific to particular embodiments of particular disclosure.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

This description shows the best mode of the present invention and provides examples to illustrate the present invention and to enable a person skilled in the art to make and use the present invention. The present invention is not limited by the specific terms used herein. Based on the above-described embodiments, one of ordinary skill in the art can modify, alter, or change the embodiments without departing from the scope of the present invention.

Accordingly, the scope of the present invention should not be limited by the described embodiments and should be defined by the appended claims.

What is claimed is:

1. A method for a parking lot operation based on a depth map, performed by a processor, the method comprising:
collecting a captured image of a target area corresponding to a parking lot through a camera;
generating a depth map for the captured image;
producing binarized data for the generated depth map;
calculating a number of vehicles parked in the target area based on the binarized data;
performing parking situation analysis according to the number of parked vehicles; and
performing processing according to a result of the parking situation analysis.

2. The method of claim 1, wherein producing the binarized data includes:
producing the binarized data through region segmentation performed by applying a threshold to the depth map.

3. The method of claim 1, wherein performing the parking situation analysis includes:
determining a number of segmented regions corresponding to vehicle objects in the binarized data as a number of currently parked vehicles.

4. The method of claim 3, wherein performing the processing includes:
checking whether parking is currently available, based on a value obtained by subtracting the number of currently parked vehicles from a total number of vehicles available for parking in the parking lot;
when the parking is currently available, creating and delivering a parking availability message to a parking control terminal placed at an entrance of the parking lot; and
when the parking is not currently available, creating and delivering a full vehicle state message to the parking control terminal placed at the entrance of the parking lot.

5. The method of claim 4, wherein performing the processing further includes:
producing location information of a parking available zone by mapping pre-stored map information about parking zones of the parking lot and the binarized data; and
transmitting the location information of the parking available zone to the parking control terminal.

6. The method of claim 1, further comprising:
outputting at least one of an image corresponding to the parking situation analysis result or information on a number of available parking spaces on a display or to a parking control terminal placed at an entrance of the parking lot.

7. An electronic device for a parking lot operation based on a depth map, comprising:
a communication circuit receiving a captured image of a target area corresponding to a parking lot;
a memory temporarily or semi-permanently storing the received captured image; and
a processor functionally connected to the communication circuit and the memory,
the processor configured to:
generate a depth map for the captured image,
produce binarized data for the generated depth map,
calculate a number of vehicles parked in the target area based on the binarized data,
perform parking situation analysis according to the number of parked vehicles, and
perform processing according to a result of the parking situation analysis.

8. The electronic device of claim 7, wherein the processor is further configured to:
produce the binarized data through region segmentation performed by applying a threshold to the depth map.

9. The electronic device of claim 7, wherein the processor is further configured to:
determine a number of segmented regions corresponding to vehicle objects in the binarized data as a number of currently parked vehicles.

10. The electronic device of claim 9, wherein the processor is further configured to:
check whether parking is currently available, based on a value obtained by subtracting the number of currently parked vehicles from a total number of vehicles available for parking in the parking lot,
when the parking is currently available, create and deliver a parking availability message to a parking control terminal placed at an entrance of the parking lot, and
when the parking is not currently available, create and deliver a full vehicle state message to the parking control terminal placed at the entrance of the parking lot.

11. The electronic device of claim 10, wherein the processor is further configured to:
produce location information of a parking available zone by mapping pre-stored map information about parking zones of the parking lot and the binarized data, and
transmit the location information of the parking available zone to the parking control terminal.

12. The electronic device of claim 7, wherein the processor is further configured to:
output at least one of an image corresponding to the parking situation analysis result or information on a number of available parking spaces on a display or to a parking control terminal placed at an entrance of the parking lot.

13. A method for a flooding prediction, performed by a processor, the method comprising:
receiving streaming images of an area including a road;
detecting a road mask showing pixels representing the road from a plurality of frames arranged in time order in the streaming images through a segmentation model;
measuring reflectance of an area corresponding to the road mask of the plurality of frames by controlling a reflectance measurement device; and
predicting a possibility of flooding of the road by analyzing changes in reflectance corresponding to the road mask in the plurality of frames through a prediction model.

14. The method of claim 13, wherein measuring the reflectance includes:
emitting measurement light to the area corresponding to the road mask in the plurality of frames through the reflectance measurement device and receiving reflected light corresponding to the emitted light; and
measuring the reflectance through an intensity ratio of the reflected light to the measurement light.

15. The method of claim 13, wherein predicting the possibility of flooding of the road includes:
generating a string of reflectance vectors corresponding to the road masks of the plurality of frames are arranged in time order;
inputting the reflectance vector string into the prediction model; and
at the prediction model, deriving a prediction vector indicating the possibility of flooding of the road by performing a plurality of operations in which learned weights are applied to the reflectance vector string.

16. The method of claim 15, wherein deriving the prediction vector includes:
at a plurality of calculation modules of the prediction model, calculating a plurality of state vectors through a plurality of operations in which weights are applied to the plurality of reflectance vectors arranged in time order, and calculating a plurality of output vectors by reflecting the plurality of state vectors; and
at a fully connected layer of the prediction model, calculating the prediction vector by performing a plurality of operations in which weights are applied to the plurality of output vectors.

17. The method of claim 13, further comprising:
before receiving the streaming images,
preparing learning data including a string of reflectance vectors arranged in time order and including a plurality of reflectance vectors each indicating the reflectance of the road mask area, and a label indicating the reflectance of the road mask area after a predetermined time corresponding to the reflectance vector string;
inputting the reflectance vector string into a learning-uncompleted prediction model;
at the prediction model, deriving a prediction vector for predicting the reflectance of the road mask area after a predetermined time by performing a plurality of operations in which learning-uncompleted weights are applied to the plurality of reflectance vectors in the reflectance vector string;
calculating a loss representing a difference between the label and the prediction vector; and
updating the weights of the prediction model to minimize the loss.

18. The method of claim 13, further comprising:
before receiving the streaming images,
preparing learning data including an image of the road and a target road mask showing pixels representing the road in the image;
inputting the image into a learning-uncompleted segmentation model;
at the segmentation model, deriving a segmented image including a road mask from the image through a plurality of operations in which learning-uncompleted weights are applied to the image;
calculating a loss representing a difference between the road mask of the segmented image and the target road mask; and
performing optimization to modify the weights of the segmentation model to minimize the loss.

19. An electronic device for a flooding prediction, comprising:
a data processor receiving streaming images of an area including a road;
a road detector detecting a road mask showing pixels representing the road from a plurality of frames arranged in time order in the streaming images through a segmentation model;
a reflectance measurer measuring reflectance of an area corresponding to the road mask of the plurality of frames by controlling a reflectance measurement device; and
a flood predictor predicting a possibility of flooding of the road by analyzing changes in reflectance corresponding to the road mask in the plurality of frames through a prediction model.

20. The electronic device of claim 19, wherein the reflectance measurer:
emits measurement light to the area corresponding to the road mask in the plurality of frames through the reflectance measurement device, receives reflected light corresponding to the emitted light, and measures the reflectance through an intensity ratio of the reflected light to the measurement light.

21. The electronic device of claim 19, wherein the flood predictor:
generates a string of reflectance vectors corresponding to the road masks of the plurality of frames are arranged in time order,
inputs the reflectance vector string into the prediction model, and
enables the prediction model to derive a prediction vector indicating the possibility of flooding of the road by performing a plurality of operations in which learned weights are applied to the reflectance vector string.

22. The electronic device of claim 21, wherein the prediction model includes:
a plurality of calculation modules calculating a plurality of state vectors through a plurality of operations in which weights are applied to the plurality of reflectance vectors arranged in time order, and calculating a plurality of output vectors by reflecting the plurality of state vectors; and
a fully connected layer calculating the prediction vector by performing a plurality of operations in which weights are applied to the plurality of output vectors.

23. The electronic device of claim 19, further comprising:
a model creator configured to:
prepare learning data including a string of reflectance vectors arranged in time order and including a plurality of reflectance vectors each indicating the reflectance of the road mask area, and a label indicating the reflectance of the road mask area after a predetermined time corresponding to the reflectance vector string,
input the reflectance vector string into a learning-uncompleted prediction model,
enable the prediction model to derive a prediction vector for predicting the reflectance of the road mask area after a predetermined time by performing a plurality of operations in which learning-uncompleted weights are applied to the plurality of reflectance vectors in the reflectance vector string,
calculate a loss representing a difference between the label and the prediction vector, and
update the weights of the prediction model to minimize the loss.

24. The electronic device of claim 19, further comprising:
a model creator configured to:
prepare learning data including an image of the road and a target road mask showing pixels representing the road in the image,
input the image into a learning-uncompleted segmentation model,
enable the segmentation model to derive a segmented image including a road mask from the image through a plurality of operations in which learning-uncompleted weights are applied to the image,
calculate a loss representing a difference between the road mask of the segmented image and the target road mask, and
perform optimization to modify the weights of the segmentation model to minimize the loss.
